(19) United States
(12) Patent Application Publication
(10) Pub. No.: US 2005/0253554 A1
(43) Pub. Date: Nov. 17, 2005

(54) Apparatus for backing up data stored in a portable device

(75) Inventors: Robert A. DiFazio, Greenlawn, NY (US); Steven J. Goldberg, Downingtown, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 10/901,794

(22) Filed: Jul. 29, 2004

Related U.S. Application Data
(60) Provisional application No. 60/571,302, filed on May 14, 2004.

(51) Int. Cl. H02J 7/00

(52) U.S. Cl. 320/114

(57) ABSTRACT

The present invention is related to a data backup device performing backup of data stored in a portable device while charging a battery in the portable device. The present invention incorporates a data backup mechanism into a charger and a portable device. When the portable device is connected to the charger for charging the battery of the portable device, the charger automatically retrieves data in the portable device, and stores it in a non-volatile memory of the charger. If a portable device is lost or malfunctions, or a new portable device is purchased, the data stored in the portable device can be easily recovered from the non-volatile memory.

### CROSS REFERENCE TO RELATED APPLICATIONS

This application claims priority from U.S. provisional application No. 60/571,302 filed May 14, 2004, which is incorporated by reference as if fully set forth.

### FIELD OF INVENTION

The present invention is related to a data back-up device. More particularly, the present invention is related to a battery charger performing a back-up of data stored in a portable device while charging a battery in the portable device.

### BACKGROUND

Portable devices, such as cellular phones, personal data assistants, or smart phones, are widely used, and the use of such portable devices is expected to increase in the future. Users typically store personal data, such as telephone numbers, email addresses, mailing addresses or other information such as personal memos in the portable devices. Users also normally configure the portable devices in accordance with the users' preference, and the configuration data, such as cellular phone ring tones, is stored in the portable devices.

Along with the convenience, portable devices may sometimes present difficulties to users. If a user loses the portable device, or the portable device malfunctions, the user may be unable to recover the personal data or the configuration data stored in the portable device. A loss of such data could be devastating to the user. Even if the data is recoverable, the user must often spend a lot of time recovering the data. To prevent the loss of data, users can backup data in a separate storage medium.

The prior art teaches backing up data in portable devices via an interface to a personal computer. The interface may be wireless (RF or infrared) or wired. The backup process is indispensable for protection of data from loss or malfunction of the devices. However, prior art backup processes require users to regularly follow a specific procedure to backup the data. Many users, however, ignore the process even though they recognize the necessity of regular backups.

Therefore, there is a pressing need for a more convenient backup process without requiring a user's active participation in a separate and/or complicated backup process.

### SUMMARY OF THE INVENTION

The present invention is related to a battery charger which performs a back-up of data stored in a portable device while charging a battery in the portable device. The invention incorporates a data backup mechanism into a charger and a portable device. The charger comprises an interface to a portable device, and a non-volatile memory. When the portable device is connected to the charger for charging the battery of the portable device, data in the portable device is automatically retrieved and stored in a non-volatile memory of the charger. By incorporating a non-volatile memory into a charger, the backup process can be conveniently combined with the charging process. If a portable device is lost or malfunctions, or a new portable device is purchased, the configuration data or personal data originally stored in the portable device can be quickly and easily recovered from the non-volatile memory.

### BRIEF DESCRIPTION OF THE DRAWINGS

FIG. 1 is a perspective view of a portable device installed in a charger in accordance with one embodiment of the present invention.

FIG. 2 is a block diagram of a portable device and a charger for backing up data stored in the portable device in accordance with the present invention.

### DETAILED DESCRIPTION OF THE PREFERRED EMBODIMENTS

The present invention will be described with reference to the drawing figures wherein like numerals represent like elements throughout. A portable device used hereinafter includes, but is not limited to, a cellular phone, a personal data assistant, a palm-top computer, an internet phone, a pager, a notebook computer, a voice recorder, an MP3 or CD player, or any other portable device that is configured to store user data in an internal storage medium.

Portable devices are typically battery operated and these batteries need to be recharged. A charger is usually provided with the portable device, and users usually locate the charger at home, in the office, or within a vehicle to recharge the portable device.

The charger may be a cradle into which the portable device can be conveniently inserted; any AC-operated charger that connects to the portable device by a cable or other connector; a charger that operates off a portable power source such as in an automobile, an airplane, or a boat; or a charger that operates off stand-alone power sources such as a generator, an inverter or batteries.

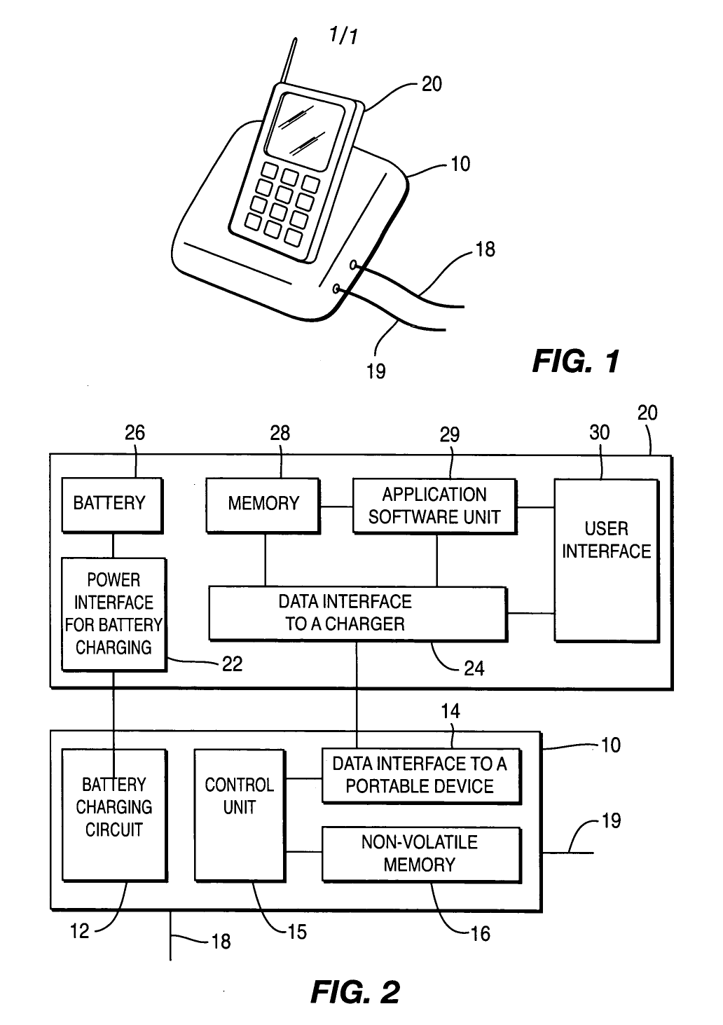

FIG. 1 is a perspective view of a portable device 20 and a charger 10 in accordance with one embodiment of the present invention. The portable device 20 is installed into the charger 10 for charging the battery of the portable device 20. While the battery of the portable device 20 is being charged, data stored in the portable device 20 is copied and stored in the charger 10. Although, only a cellular phone and a cradle-type charger are illustrated in FIG. 1, it should be understood that any kind of portable device and any type of charger may be utilized in implementation of the teaching of the present invention.

FIG. 2 is a block diagram of a portable device 20 and a charger 10 in accordance with the present invention. The present invention incorporates a data backup mechanism into a charger 10 and a portable device 20. The charger 10 comprises a battery charging circuit 12, a data interface to a portable device 14, a non-volatile memory 16, and a connection 19 to a power source (not shown). The charger 10 preferably includes an external data interface 18. The portable device 20 comprises a battery 26, a power interface for battery charging 22, a data interface 24, a memory 28, and an application software unit (ASU) 29. While this figure shows separate power and data connections between the portable device 20 and the charger 10, the same utility can be supported by a combined cable supporting both functions with separate wires, or a single pair of wires that support both the power and data functions.

The non-volatile memory 16 in the charger 10 stores data received from the portable device 20. The non-volatile memory 16 is able to store one backup, or a plurality of backups as desired by a user. By incorporating the non-volatile memory 16 into a charger 10, and the appropriate interfaces and application software on the charger 10 and the portable device 20, the backup process can be conveniently combined with the charging process as will be described in detail hereinafter.

Both the backup process and the charging process are automatically invoked upon connecting the portable device 20 to the charger 10, for example, as shown in FIG. 1, by placing the portable device 20 in the cradle of the charger 10. As will be described in detail hereinafter, if the portable device 20 is lost or malfunctions, or a new portable device is purchased, the configuration data or personal data originally stored in the portable device 20 can be quickly and easily retrieved from the non-volatile memory 16 and stored in the memory 28 of the portable device 20.

Each time the portable device 20 is placed in the charger 10, the data stored in the non-volatile memory 16 is automatically brought current, (i.e. the data stored in the non-volatile memory 16 is updated to mirror the data stored in the memory 28 of the portable device 20), through the data interfaces 14, 24. This can be performed in several different ways.

Although the ASU 29 preferably controls the data transfer process, and the process will be described as such hereinafter, either the charger 10 or the portable device 20 may control the data transfer process, whereby either the portable device 20 or the charger 10 may be a master/slave. If the portable device 20 is the master, then the portable device 20 recognizes when it is placed in the charger 10 and sends signals through the interface 24 to initiate the data exchange. If the charger 10 is the master, then the charger 10 recognizes that the portable device 20 has been inserted and sends signals through the interface 14 to initiate the data exchange.

Old data in the non-volatile memory 16 may be automatically deleted and a completely new data set is stored in its place. Alternatively, the data may remain undeleted for a certain duration of time and then deleted after the duration of time has elapsed.

Alternatively, separate versions of data may be retained until the memory capacity of the device is exceeded, and then the oldest version of the data is deleted. The ASU 29 may compare versions of data stored in the portable device 20 and the charger 10. Therefore, the current version of data in the portable device 20 is compared with the most recent version of backup data in the charger 10 so that only the new version of data is backed up in the charger 10. Preferably, if a version on the portable device 20 is identical to that in the charger 10, no backup is performed. This avoids filling the non-volatile memory 16 with multiple copies of identical data.

When needed, the backup data is restored from the non-volatile memory 16 to the memory 28. The ASU 29 allows the data in the non-volatile memory 16 to be loaded into the portable device 20 and into the memory 28. The ASU 29 sends a signal through the interface 24 indicating that data should be provided to the portable device 20 from the charger 10. Subsequently, the charger 10 sends the data to be restored across the interfaces 14, 24 to the portable device 20. As the data is received, the ASU 29 directs the data to locations in the memory 28 as required for operation of the portable device 20.

Setting up for the restore operation may include the exchange of several signals. For example, the ASU 29 may send a signal requesting that the most recent set of backup data should be restored, the charger 10 may reply with a positive acknowledgement, then the ASU 29 may send a signal requesting the start of data transfer. Alternatively, the ASU 29 may send a signal requesting a list of available backup data with identifying information such as the time and date of the backup. After the charger 10 responds with the list, the ASU 29 may request a specific subset of available backup data. Other alternatives for message transfer protocols and handshakes between the portable device 20 and the charger 10 may be implemented. It should be understood that the foregoing descriptions are provided just as an example and any variance or alternatives should belong to the scope of the present invention.

A user interface 30 of the portable device 20 in conjunction with the ASU 29 permit a user to select a particular version of data, or only a portion of data, to be loaded into the portable device 20 without replacing the full set of data. If a user purchases a new device, a full set of backup data stored in the non-volatile memory 16 would be loaded into the new portable device 20. A user connects the portable device 20 with the charger 10 and inputs a command selecting a portion or full set of data into the portable device 20 through the user interface 30 of the portable device 20. The ASU 29 retrieves the selected data from the non-volatile memory 16 of the charger 10 and restores the data to the memory 28. With this procedure, a user may recover data or set configuration of the original or a new portable device.

A user may also use this procedure to recover deleted data from the non-volatile memory 16. If a user wants to “undelete” data that was deleted erroneously or previously from the memory 28, the deleted data may be recovered from the non-volatile memory 16, if the data is still available. The ASU 29 enables a user to add the deleted data to the current data without replacing the full set.

A user may utilize both the backup and restore functions together. This swap function is useful when the portable device 20 is shared between people, or a user uses it at different times. An example of the latter is that one set of data is used for work related usage, and another set for weekends or vacation.

The backup process may be scheduled by the charger 10 or the portable device 20. The backup process is preferably automatically initiated by coupling the portable device 20 to the charger 10 without a user's active involvement. However, a user may set a schedule for backup rather than performing a backup every time the portable device 20 is connected to the charger 10 so that a user may backup data periodically or according to the schedule. Application software on the portable device 20 or the charger 10 may enable, disable, or schedule the backup processes.

The user may be given an indication when the transfer process is in progress so that the transfer process may not be interrupted while in progress. The indication may be visual and/or audio, and exist on the charger 10 or the portable device 20. Alternatively, the portable device 20 may be mechanically locked into the charger 10 during transfers.

If the transfer of data in either direction is interrupted before completion, the charger 10 and/or the portable device 20 alert the user to the interruption. The user is also able to fix it from the alert or by interrogation if the interruption is merely that a transfer of the latest version has not occurred, or if the data is corrupted. In the latter case, the user can correct the situation by reattaching the portable device 20 to the charger 10.

The charger 10 may contain a security device, such as within the control unit 15 to protect data from an unauthorized use or retrieval. For example, a charger 10 may require a password to be input before retrieving the backup data so that an authorized user can retrieve the backup data, but other unauthorized users or equipment are restricted from retrieving the data.

The ASU 29 may perform encryption of data as it is transferred to non-volatile memory 16 so that the data is further protected against unauthorized use. An authorized user or an authorized portable device has a key for decrypting the data so that the data may not be used without an authority.

As a further security measure, the control unit 15 identifies the portable device 20 or the user. The portable device 20 may be identified via an electronic serial number (ESN) or other identifier of the equipment. A user may be identified via an international mobile subscriber identifier (IMSI) or other code that uniquely identifies the user which is possibly stored in a subscriber identity module (SIM) card, or stored in the memory 28. When a portable device 20 is connected to the charger 10, the control unit 15 communicates with the ASU 29 to receive the identification information regarding the portable device 20 or the user, and permit access to the data only for the authorized portable device or user.

In a like fashion to protect the data within the charger 10, it is necessary to protect the portable device 20 from transferring data to or from an unauthorized charger. This function may be configured by the user in different modes, and can be overridden by the user by entering a fixed or changing value on the portable device 20.

Separate backups may be maintained for multiple portable devices or multiple users that share the charger 10. The charger 10 may identify the portable device 20 or the user of the portable device 20 with an identifier. The identifier of the portable device 20 or the user is provided to the charger 10 via the interface 14. The charger 10 maintains backup data for each unique identifier in a separate part of the non-volatile memory 16. Similarly, the restore operation only accesses data stored in sections of the non-volatile memory 16 associated with an identifier that has been provided to the charger 10. This permits several people, or one person with several portable devices, to share one charger 10 and benefit from the backup capability. For example, a family may purchase multiple portable devices that are compatible with one type of charger 10, and share the charger 10. The non-volatile memory 16 may maintain several backups for several users or portable devices in accordance with the identification of the user or the portable device 20.

To facilitate a use by multiple portable devices, the charger 10 may have multiple connections that accommodate multiple portable devices. The charger 10 may have a plurality of cradles or connections so that a plurality of portable devices are installed or connected to the charger 10 at the same time. The charger 10 may use a common non-volatile memory 16 to serve the plurality of cradles or connections. The charger 10 may identify the portable device 20 or the user of the portable device 20 attached to a particular cradle or connection with an identifier passed over the data interface 14 of the cradle or connection. The same part of the non-volatile memory 16 may be used for the same identifier independent of the cradle or connection to which the portable device 20 is attached. In this way, it would not matter which cradle or connection to which a portable device 20 has been attached and the charger 10 maintains separate backups for each portable device 20 or user. For example, if a family shares one charger, each family member may install their portable devices 20 in the charger at the same time, using any available cradle or connection, while data is also backed up from each portable device 20 to the non-volatile memory 16 of the charger.

The charger 10 preferably has an additional external interface 18 to a personal computer (PC), a local area network (LAN), a wide area network (WAN), or a cellular network, (shown as singularly as external data interface 18), to save the data stored in the non-volatile memory 16. The data in the non-volatile memory 16 may be transferred to another storage medium outside the charger 10 via the external data interface 18. The interface 18 may be wired or wireless. The interface 18 may use standard communication protocols, such as Ethernet, 802.11, Bluetooth, USB and infrared, or may use a special purpose wired or wireless protocol. This provides another degree of insurance against loss of data or malfunction of a portable device 20. The interface 18 may allow a user to remotely access the data in the non-volatile memory 16, should there be a need to recover data from a remote location. The data may be accessed through the Internet, and stored remotely, or retrieved or updated through the external data interface 18. The external data interface 18 to the PC or network may allow software upgrades to be loaded into the charger 10 using the external data interface 18. Therefore, a user may upgrade application software running in the charger 10 by downloading the upgraded software from a network into the charger 10.

The remote access also allows the control and status interface functions to be performed by a device other than the charger 10 and portable device 20. This is desirable in that other devices have a superior entry and display capability. Standard security safeguards will be provided to prevent unauthorized access.

The external data interface 18 to the PC or network may enable a plurality of chargers to communicate each other. This allows backup data from one charger to be loaded into another charger. Therefore, if a user wants to replace or upgrade a charger, the data stored in one charger may be conveniently restored into another charger.

The external data interface 18 may also allow a network operator to monitor the use of the charger 10, determine what devices are plugged into the charger 10, or check for malfunctions of the charger 10 or the portable device 20. A charger may transmit a communication via the external data interface 18 regarding the usage or condition of the charger 10 or a portable device 20 connected to the charger 10. This allows the operator to provide additional services to the user or offer new/upgraded products based on use patterns.

1. A charger configured to backup data in a portable device while charging a battery of the portable device, the charger comprising:
an interface for transmitting and receiving data to and from the portable device;
a memory for storing data received from the portable device through the interface; and,
means for charging a battery in the portable device.

2. The charger of claim 1 wherein the memory is configured to compare the data stored in the charger and the data stored in the portable device, whereby maintaining a plurality of version of data in the charger.

3. The charger of claim 2 wherein an older version of the data in the memory is deleted after a certain period of time elapsed.

4. The charger of claim 2 wherein the memory stores data only when the data in the portable device is different from the data stored in the memory.

5. The charger of claim 2 wherein the memory retains separate versions of the data until the memory is full, and then deletes the oldest version of the data.

6. The charger of claim 1 further comprising a means for identifying the portable device.

7. The charger of claim 6 wherein said identifying means identifies the portable device with at least one of electronic serial number (ESN), international mobile subscriber identity (IMSI), and subscriber identity module (SIM) card.

8. The charger of claim 6 wherein the memory stores a plurality of backups for more than one portable device.

9. The charger of claim 1 further comprising an external interface for transmitting and receiving data to and from an external device.

10. The charger of claim 9 wherein the external interface is a wireless interface.

11. The charger of claim 9 wherein the external interface is a wired interface.

12. The charger of claim 1 wherein the data backup is initiated when the portable device is connected to the charger.

13. The charger of claim 1 further comprising a means for scheduling initiation of data backup, whereby data backup is performed according to the schedule.

14. The charger of claim 1 further comprising a means for selecting a portion of data for storing in the memory.

15. The charger of claim 1 further comprising a security means for requiring to initiate data backup.

16. The charger of claim 1 further comprising an encryption means for encrypting the stored data.

17. The charger of claim 1 wherein the charger comprises more than one interface, whereby more than one portable device is connected to the charger at the same time.

18. The charger of claim 1 further comprising a means for identifying itself to the portable device.

19. The charger of claim 18 wherein the identifying means identifies the charger with at least one of electronic serial number (ESN), and a challenge and response sequence.
